(19) United States
(12) Patent Application Publication
(10) Pub. No.: US 2009/0240936 A1
(43) Pub. Date: Sep. 24, 2009

(54) SYSTEM AND METHOD FOR STORING CLIENT-SIDE CERTIFICATE CREDENTIALS

(76) Inventors: MARK LAMBIASE, Ladera Ranch, CA (US); Garret Grajek, Aliso Viejo, CA (US); Stephen Moore, Portland, OR (US)

Correspondence Address: STETINA BRUNDA GARRED & BRUCKER, 75 ENTERPRISE, SUITE 250, ALISO VIEJO, CA, 92656, US

(21) Appl. No.: 12/052,630

(22) Filed: Mar. 20, 2008

(51) Int. Cl. H04L 9/00

(52) U.S. Cl. 713/156

(57) ABSTRACT

A method and system is provided for storing a plurality of client certificate credentials via a client web browser into one or more keystore file(s). The client web browser is used to establish the secure data transfer link between the client and the server. The client web browser includes a plug-in software component. The plug-in software component is configured to generate the keystore file and a key pair. The method may continue with generating a certificate request on the client. The certificate request generated is then transmitted to a certificate server. The certificate server is configured to digitally sign the certificate request generated. The method continues with the client receiving a signed certificate request. The signed certificate request is received by the client via the client web browser. The method may conclude by storing the plurality of client certificate credentials associated with the signed certificate request in one or more keystore file(s).

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention generally relates to a method and system for storing client certificate credentials. More particularly, the present invention relates to a method and system for automated client self-service storage of a plurality of client certificate credentials in a keystore file via a client web browser.

2. Related Art

Public Key Infrastructure (PKI) enables computers without prior contact to be authenticated to each other and to use the public key information in their public key certificates to encrypt messages to each other. In general, a PKI consists of client software, server software, hardware and operational procedures. PKI is a vital role player relating to secure communications across the Internet. Banking, financial services, government, education, and all varieties of companies rely upon advanced computer systems and data communication networks such as the Internet. While such advancements have greatly increased the speed and convenience with which business is conducted, numerous vulnerabilities compromise the security of the highly sensitive and confidential data being exchanged. At the most basic level, electronic transactions typically involve a server computer system and a client computer system communicating over a network. Additional client or server computer systems may also be connected to the network, such that multiple clients may access a given server, or multiple servers may be accessed by a given client. In this open network environment, there are three primary concerns for data security. First, the server must be assured that the client is what it asserts it is. Second, the client must be assured that the server is what it asserts it is. Third, any information being exchanged between a legitimate server and a legitimate client must not be intercepted or altered by any other computer systems or users on the network.

In the electronic banking setting, for example, the bank must authenticate the identity of the user accessing the banking server, so that transactions relating only to a particular customer are permitted, and that the user accessing the banking server is verified as the customer or someone given authority by the customer. The client must be ensured that the banking server is, indeed, the server operated by the bank, and not a similar one operated by a malicious entity. This is known as a phishing attack, where a fake server is made to resemble the legitimate server, and tricks the user into providing confidential information such as bank account numbers, social security numbers, passwords, and the like. Much harm may be inflicted on the customer by a criminal possessing such information, including erroneous accumulation of debt, arrest records, criminal convictions, destruction of creditworthiness, damage to reputation, and so forth. These are also known as identity theft crimes. Because confidential information is being transmitted over an open network, such information must be encrypted or otherwise rendered incomprehensible to any other system besides the client and the server. The open nature of the network renders computer systems susceptible to replay attacks, where a valid data transmission is intercepted and repeated later for fraudulent or malicious purposes. For example, passwords or other authentication information may be intercepted, and used later to gain access to sensitive information. Further, the information being transmitted on the network must not be modifiable, such as in the case of man-in-the-middle attacks. This involves an attacker reading, inserting and modifying data between a legitimate client and server with neither recognizing the compromised nature of the link.

Generally, these security considerations are of primary importance in all networking environments where sensitive and/or confidential data is being exchanged. Many business organizations currently utilize Virtual Private Networks (VPNs) for secure remote access via public networks such as the Internet to the organization's internal network resources. Without proper safeguards that prevent the above-described attacks, the security of the organization's data as well as the organization's customers' or clients' data may be compromised, leading to even greater losses than that affecting just one individual.

Generally, public key encryption involves a unique public/private key pair held by both the recipient and the sender. The private key of the sender is retained solely by the sender, and the private key of the recipient is retained solely by the recipient. The public key of the sender is distributed and is held by the recipient, and the public key of the recipient is also distributed and held by the sender. When transmitting a message, the sender's private key and the recipient's public key are used to encrypt the message. The message is decrypted by the recipient using the recipient's private key and the sender's public key.

A digital certificate is a computer-generated record that connects the client's identification with the client's public key in a trusted bond. The trust is based on a registration/identification policy enforced by a third party, Certification Authority. The certificate may contain the following: identification of the Certification Authority issuing the certification; the client; the client's public key; and is digitally signed by the issuing Certification Authority. Digital signatures are a common method used to authenticate one device to another device. Certificates provide a key distribution mechanism that is required by digital signatures and public key cryptography. To use digital signatures, private information (the private key) must be stored on the device that is providing the signature. The stored private information may aid an attacker who steals the hardware device that contains the private key; for example, an attacker may be able to cause the router to initiate a secure connection to another site by using the RSA private keys stored in the router.

In cryptography, a well known certificate standard is the X.509 certificate. The structure of a certificate may include version, serial number, algorithm ID, issue, validity, subject, subject public key info, issuer unique identifier, subject unique identifier, extensions, certificate signature algorithm, and certificate signature. The certificate is the International Telecommunications Union—Telecommunication Standardization Section (ITU-T) recommendation that defines a framework for the provision of authentication services under a central control paradigm represented by a “Directory.” The recommendation describes two levels: simple authentication, using a password as verification of claimed identity, and strong authentication, involving credentials formed by using cryptographic techniques, the “certificate.” The format of the certificate structure is defined along with responsibilities of the Certification Authority in regards to establishing and maintaining trust.

Certificates such as the X.509 standard, certificate chains, and private keys are stored in what is known as a keystore file. Typically, keystore files are encrypted to protect the information stored within the file. The information stored in a keystore file is confidential due to security considerations described above. Keystore files may be accessed using two passwords. One password provides access to the keystore file and a separate second password provides access to the private key stored within the keystore file. There are several developed standards for protected keystore files. The most widespread being the PKCS #12 standard. The PKCS #12 standards provides a keystore defined by a file format commonly used to store private keys with accompanying public key certificates, and protected with a password-based symmetric key. This is a container format that can contain multiple embedded objects including multiple certificates by way of example. This standard format may be used with the Java keystore. When a Certification Authority issues a digital certificate to a client, the client ultimately gets a protected keystore file, which contains the issued certificate, its corresponding private key, and the whole certificate chain, providing the certificate's authenticity. The protected keystore file may be given to the client in the form a file, as a smart card, or may be directly installed on the client and/or the client's web browser.

A proven method to authenticate across the Internet in a manner that ensures the validity of the end user is to use public/private key pairs to digitally sign an authentication request. In this scenario an authentication server sends a message to a client with an expectation that the client will validate its identity by signing the message with the user's private key. Most often this message is a digitally hashed message, utilizing some common hashing mechanism such as MD2, MD4, MD5, SHA1 or some other hash algorithm. The client runs the hash and then signs this hash with the user's private key and returns this digitally signed message to the server. The server, utilizing the same hashing algorithm, then digitally hashes the same message and stores this value, for comparison later, this hash value is called the “Current Hash Value.” The server then takes the digitally signed signature from the client and decrypts this hash value with the user's public key. The server then compares this decrypted digital signature with the Current Hash-Value, if the two are not identical, the digital signature is invalid and the verification is unsuccessful. The client's web browser may prove instrumental in the issuance procedure. In a request for a certificate issuance (a certificate request) sent to a given certification authority from a server or website, the client's web browser may generate a public/private key pair and sends the public key to the certificate authority's server. The client web browser keeps the private key a secret and does not send it to the certificate authority. The certificate authority, after verifying the authenticity of its client's personal identity data, issues the client a certificate in which it records the public key received by the client's web browser and the client's confirmed identity data. After the certification authority's server issues the certificate to its client, it redirects the client to the Web page from which the certificate can be installed in the client's web browser. The web browser has stored the private key corresponding to the certificate and, at the end, the user obtains a certificate and its corresponding private key, along with the certificate chain of the certificate, installed in the client's web browser. The method of storing private keys generally varies depending on the web browser.

Most client web browsers can use the certificates and private keys stored within for authentication before secure SSL servers. Many e-mail clients can also use the certificates stored in the client web browsers for signing, encrypting, and decrypting electronic mail. However, some applications cannot directly use the certificates from the client's web browsers, but can work with certain keystore files. In such cases, the user of the client may export their certificates from their client web browsers, along with their corresponding private keys in a keystore file and use them in any other application. There are several standards for storing X.509 digital certificates. Most frequently, ASN.1 DER encoding is used, in which the certificates are stored in files with a .CER extension. A CER file contains a public key, information about its owner, and a digital signature of a certificate authority, certifying that the public key really belongs to the user or client. The Certificate Authority distributes from their sites their Root certificates in .CER files. A .CER file can be stored in binary format or text format, encoded with Base64.

Many keystore file applications are independent of an authentication mechanism. These keystore file applications search for and utilize the public/private keys in multiple storage areas. These third party applications typically cannot search for the public/private keys or other certificate credentials in other keystore file locations. Alternatively, the third party applications may search for the plurality of client certificate credentials in other keystore file locations only after the applications are re-written. Re-writing the third party applications to search for keystore file locations that normally the applications are not designed to search is difficult and is not recommended for most users of client computers. A common problem is applications look for the plurality of client certificate credentials to be stored in a Java keystore. Since most authentication solutions store the plurality of client certificate credentials in browser-only keystore file, the application cannot find the credentials and thus may not authenticate the user, thus making the application futile. The solution in the past to this problem was for the user to manually extract and replicate the certificate information in other keystore files. As mentioned above, this is a difficult procedure fraught with error and beyond the technical ability of most users.

There is a need in the art for an improved method and system for storing client certificate credentials within a keystore file or a plurality of keystore files.

### BRIEF SUMMARY

In accordance with one embodiment of the present invention, there is provided a method for storing a plurality of client certificate credentials via a client web browser into a keystore file. The method begins with establishing a secure data transfer link between a client and a server. The client web browser is used to establish the secure data transfer link between the client and the server. The client web browser includes a plug-in software component. The plug-in software component is configured to generate the keystore file and a key pair including a public and private key during the process wherein the secure data transfer link is established between the client and the server. The method may continue with generating a certificate request on the client. The certificate request generated includes the public key from the key pair generated by the plug-in software component to the client web browser. The certificate request generated is then transmitted to a certificate server. The certificate server is configured to digitally sign the certificate request generated. The method continues with the client receiving a signed certificate request. The signed certificate request is received by the client via the client web browser. The method may conclude by storing the plurality of client certificate credentials associated with the signed certificate request in the keystore file.

According to another embodiment of the present invention, the plurality of client certificate credentials include a digital certificate, a private key, a public key, a certificate chain, and a plurality of client identifying information. In another aspect of the present invention, establishing the secure data transfer link between the client and the server requires the client to successfully complete a multi-factor authentication process with the server. It is also contemplated that the plug-in software component is a browser-executable code transmitted to the client web browser from the server. The plug-in software component may be configured to generate a plurality of keystore files. The plug-in software component may selectively store the plurality of client certificate credentials. The plurality of client certificate credentials to be selectively stored by the plug-in software component is associated with the signed certificate request. The plurality of client certificate credentials may be stored in the plurality of keystore files generated by the plug-in software component. The method may also contemplate the server being a Secure Sockets Layer (SSL) Virtual Private Network (VPN). It is also contemplated that the certificate server is a certificate authority remote from the client and the server. The keystore file to be selected for storing the plurality of client certificate credentials may be selected from a group consisting of Microsoft crypto API keystore, Java keystore, Apple keystore and NSS keystore. However, the above keystore types are merely examples, the present invention contemplates utilizing additional keystores not listed as examples herein. The plug-in software component may identify the client web browser and store the plurality of client certificate credentials in the keystore files associated with the client web browser's coded libraries.

In yet another embodiment of the present invention, a system is provided for storing a plurality of client certificate credentials. The system includes a client web browser on a client for establishing a secure data transfer link between the client and a server. The system also includes a plurality of keystore files. The plurality of keystore files are generated by the client web browser. The system may also include a certificate server. The certificate server is capable of receiving a certificate request generated by the client. The certificate server is configured to digitally sign the certificate request. The system includes a plug-in software component. The plug-in software component is an add-on to the client web browser. The client web browser processes the plug-in software component to generate a key pair including a public key and a private key. The plug-in software component is also configured to selectively store the plurality of client certificate credentials. An aspect of the present invention contemplates the plug-in software component storing the plurality of client certificate credentials in at least one keystore file from the plurality of keystore files. In another embodiment of the present invention, the plug-in software component stores the plurality of client certificate credentials in the plurality of keystore files.

It is also contemplated that the plurality of client certificate credentials to be selectively stored in the keystore files include a digital certificate, a client private key, a client public key, a certificate chain, and a plurality of client identifying information. The client web browser of the system establishes the secure data transfer link by successfully completing a multi-factor authentication process with the server. The certificate server included in the system is a certificate authority remote from the client and the server. In another embodiment of the present invention the certificate server is hosted at the server. The client web browser of the system is configured to generate the digital certificate. The digital certificate is typically generated in response to receiving a signed certificate request. The digital certificate will include the information verified by the certificate server. The plug-in software component of the system is a browser-executable code transmitted to the client web browser from the server. In another embodiment of the present invention the plug-in software component is a browser-executable code added onto the client web browser through an installation process on the client independent of the server.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating an environment in which one aspect of the present invention may be implemented, including various interconnected servers, clients and Virtual Private Networks (VPNs);

FIG. 2 is a flowchart illustrating a method for storing the plurality of client certificate credentials in accordance with an aspect of the present invention;

FIG. 3 is a first exemplary configuration for storing client certificate credentials in response to an authentication of the client to the server; and

FIG. 4 is a second exemplary configuration illustrating an environment in which one aspect of the present invention may be implemented.

Common reference numerals are used throughout the drawings and the detailed description to indicate the same elements.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed. It is further understood that the use of relational terms such as first and second, and the like are used solely to distinguish one from another entity without necessarily requiring or implying any actual such relationship or order between such entities.

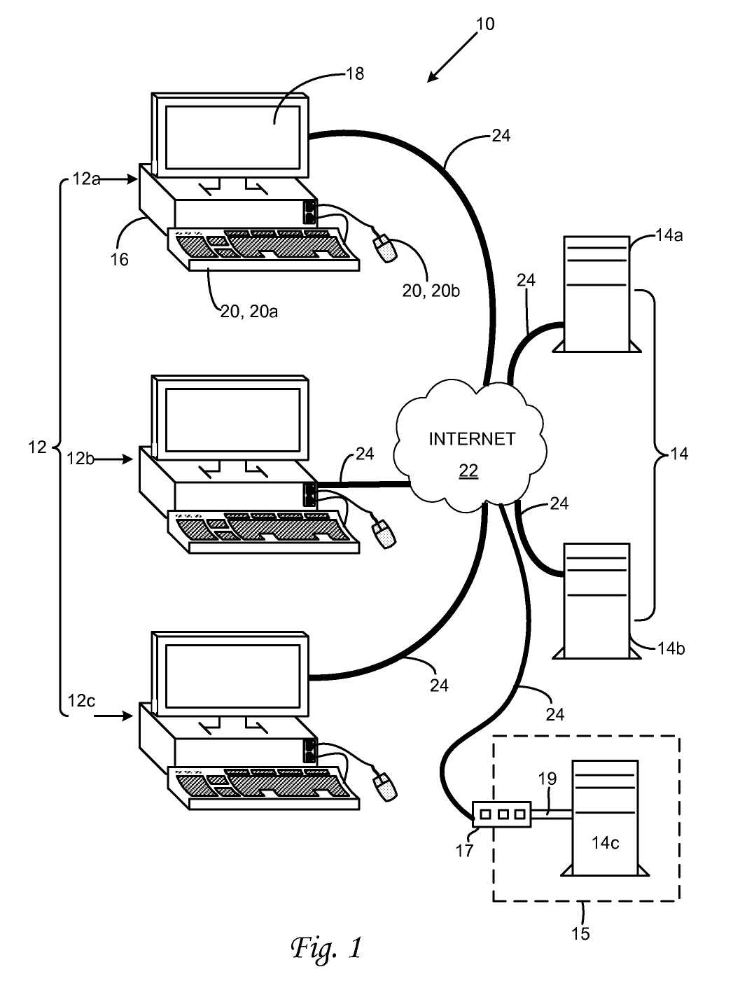

With reference to FIG. 1, an exemplary computer network 10 includes various data processing apparatuses or computers 12, 14. More particularly, the computers 12 may be personal computers or workstations that function as clients, and include a system unit 16 that houses a central processing unit, storage devices, and the like. The computers 12 may also include a display unit 18, and input devices 20 such as a keyboard 20a and a mouse 20b. It is understood that the system unit 16 receives various inputs from the input devices 20 that alter the control and flow of preprogrammed instructions being executed by the central processing unit, and the results of such execution are shown on the display unit 18. The computers 14 may be servers that provide data or services to the client computers 12. In this regard, the term “client” is understood to refer to the role of the computers 12 as a requester of data or services, while the term “server” is understood to refer to the role of the servers 14 to provide such data or services. Additionally, it is possible that the computers 12 may request data or services in one transaction and provide data or services in a transaction, thus changing its role from client to server or vice versa. It is further understood that the term “server” as utilized herein may also refer generally to networked services such as a Secure Sockets Layer/Transport Layer Security (SSL/TLS) Virtual Private Network (VPN), through which conventional servers 14 provide data and software applications to remote clients.

The computers 12, 14 are connected to a wide area network such as the Internet 22 via network connections 24. Requests from the client computers 12 and requested data from the server computers 14 are delivered through the network connections 24. According to an embodiment of the present invention, the server computers 14 are web servers, and the client computers 12 may include web browsing applications such as Microsoft Internet Explorer that visually renders documents provided by the server computers 14 on the display unit 18. It will be appreciated that the network topology shown in FIG. 1 is presented by way of example only and not of limitation, and any other type of local or wide area network may be readily substituted without departing from the scope of the present invention. It is understood that any well known data transmission protocol may be utilized for the network connections 24 and the Internet 22.

As a further example, a first server computer 14a may be an electronic banking web server that provides account information and funds transfer functionality. Additional uses are also contemplated, where the first server computer 14a hosts a mail server, an online shopping site, or a Microsoft .NET application. A user on the first client computer 12a may log on to first server computer 14a to retrieve the account balance and transfer funds to a separate account using a client web browser. In this exemplary context, one of the considerations of information security includes ensuring that the user on the first client computer 12a is who he asserts to be. For example, a malicious user on a second client computer 12b may have all of the credentials of the user on the first client computer 12a to log on to the first server computer 14a without recognizing that such access is fraudulent. Another consideration is ensuring that the first server computer 14a is under the control of a bank of which the user on the first client computer 12a is a customer. It may be possible that the second server computer 14b is masquerading as the first server computer 14a in a phishing attempt, and the first client computer 12a may have been misdirected to the second server computer 14b. Additionally, all legitimate data transfers between the first client computer 12a and the first server computer 14a must not be intercepted by any of the other computers, including a third client computer 12c, the second client computer 12b, and the second server computer 14b.

As indicated above, instead of a specific server computer 14a, the clients 12 may access a Virtual Private Network (“VPN”) 15. The VPN 15 may be connected to the Internet 22 via a VPN router 17 for permitting remote access to the clients 12. It is understood that the VPN router 17 is the only modality through which outside clients 12 may access a server 14c on a local network 19. The same security concerns noted above are equally applicable to the VPN 15, and thus it is contemplated that the methods and systems of the present invention may be implemented therefore, as will be described in further detail below.

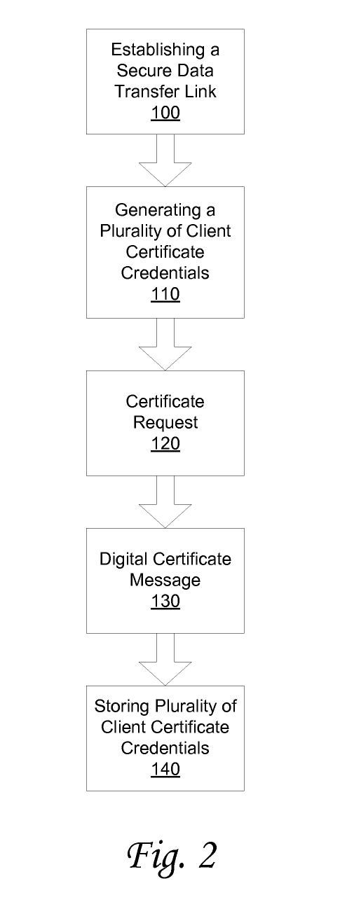

With reference to the flowchart of FIG. 2, the diagram illustrates the various steps for selectively storing a plurality of client certificate credentials in a keystore file. The keystore file is an in-memory collection of key pairs, digital certificates and other client certificate credentials. For example, a keystore file may hold very sensitive cryptographic key information, which is stored in a protected format to prevent unauthorized access. Typically, the credential stored in this type of entry is a private key accompanied by the certificate chain for the corresponding public key. Private keys and certificate chains are used by a given entity for self-authentication. A trusted certificate entry contains a single public key certificate belonging to another party. It is called a trusted certificate because the keystore file owner trusts that the public key in the certificate belongs to the identity identified by the subject (owner) of the certificate. The enrollment process for certificate keystore files is usually based on proprietary client software and/or a manual administrator initiated process. Further, this process may be delegated to the users of the client computers 12. However, the security of the encrypted keystore files may be based on multi-factor authentication.

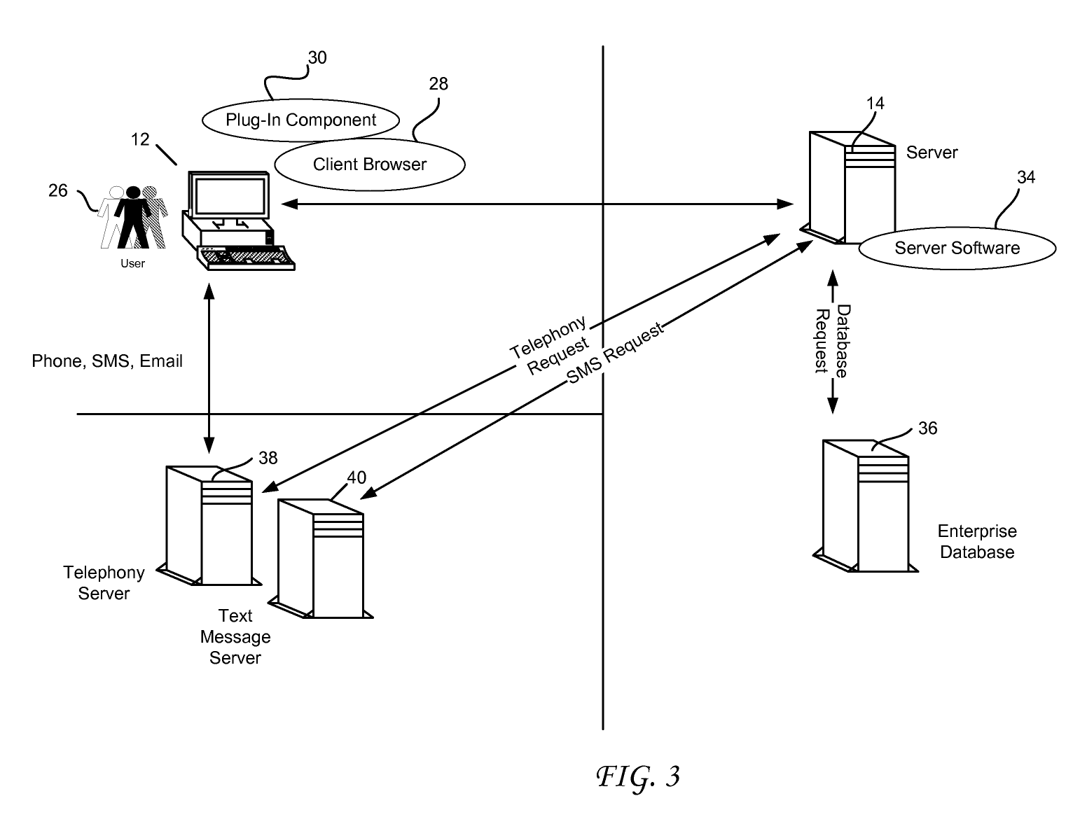

In particular, the first step of the flow chart disclosed in FIG. 2, contemplates establishing a secure data transfer link 100 between the client 12 and the server 14. In one embodiment of the present invention, it is contemplated that the secure data transfer link 100 is established only after the client 12 is successfully authenticated to the server 14. The process of authenticating the client 12 to the server 14 involves a multi-factor authentication. Referring now to FIG. 3, the multi-factor authentication process of the client is illustrated. The secure data transfer link 100 may be established between the client 12 and the server 14 by registering the client 12 with the server 14 and successfully completing a multi-factor authentication process to ensure that the client 12 is not an impostor or hacker and to secure all communications between the client 12 and the server 14. A user 26 of the client 12 may initiate the registration and authentication process by establishing an unsecured connection with the server 14. For example, the user 26 may input a network address associated with the server computer 14 into a client web browser 28 on the client 12, at which point a request is made for a file or web page on the server 14. In response, the server 14 may request information to determine if the user 26 of the client 12 is authorized to access the server 14. The interaction contemplated between the client 12 and the server 14 may include the client 12 logging onto the server 14 via the client browser 28. The information requested for example may include a username or a password. The client web browser 28 on the client 12 then requires the user 26 to input the username and/or password to gain access to the server 14. The server 14 may then determine if the information provided by the user 26 of the client 12 is correct. The server 14 via a server software application 34 may be in communication with an enterprise database 36 which may function as a back-end data store. The database 36 may include the user's 26 username and password to determine if the user 26 provided the correct identifying information. In one embodiment of the present invention, the database 36 is hosted by the server 14. In another embodiment, the database 36 is a remote server in communication with the server software application 34 via the network connection 24 or the Internet 22. The server 14 may be an Active Directory server, a Lightweight Directory Access Protocol (LDAP) server, a database server, and so forth. The server software application 34 is hosted by the server 14. It is contemplated that the server software application 34 is in communication with the client web browser 28 and therefore the client 12.

Prior to successfully authenticating the client 12, the user 26 associated therewith can be authenticated via an out-of-band modality. According to one embodiment, the server software application 34 notifies a telephony server 38 to deliver a one-time password to a mobile phone or a landline phone under the control of the user 26. Alternatively, an e-mail or a Short Message Service (SMS) text message may be sent from a text message server 40. Other out-of-band authentication techniques are contemplated, such as voice recognition, IP address verification, and the like. The entry of the one-time password may be handled through the server 14 with the server software application 34. In lieu of, or in addition to the foregoing out-of-band authentication, the user 26 may be presented with an additional knowledge-based authentication scheme. For example, the user 26 may be asked about their favorite color, their mother's maiden name, and other similar questions. Additional authentication information may be stored in the database 36 for later retrieval and use by the server software application 34. It is understood that the foregoing procedure “registers” the client web browser 28 on the client 12 with the server 14, effectively making such web browser 28 a second authentication factor (“Something the user has”). As indicated above, the one-time-password is delivered over a communications modality that is independent of, or out-of-band with respect to, the data communication link between the client 12 and the server 14. The telephony sever 38 may be managed by a third party, or by the organization that manages the server 14 or the database 36. The server software application 34 directs the user 26 on the client 12 to enter an authoritative response. Along these lines, it is understood that the telephony server 38 and the step of transmitting the authoritative response to the client 12 may be omitted, where the authoritative response is an answer to a knowledge-based question. This answer is contemplated as being pre-defined by the user 26 at an earlier time.

Subsequent to establishing the secure data transfer link 100 through a multi-factor authentication process, the next step of the flow chart of FIG. 2 includes generating a plurality of client certificate credentials 110. The plurality of client certificate credentials may include a key pair consisting of a public and a private key. This step also contemplates generating the keystore file for storing the plurality of client certificate credentials. Referring again to FIG. 3, the client web browser 28 on the client device 12 includes a plug-in software component 30 for generating the keystore file and the key pair in response to establishing the secure data transfer link 100. An aspect of the present invention contemplates that the plug-in component 30 generates the key pair after a successful authentication with the server software application 34 hosted on the server 14. In one embodiment of the present invention, the plug-in component 30 is a browser executable code implemented as an add-on to the client web browser 28. The plug-in component 30 may be transmitted from the server 14 after establishing the secure data transfer link 100. It is also contemplated that the plug-in component 30 may be transmitted to the client web browser 28 prior to establishing the secure data transfer link 100. Additionally, the browser executable code comprising the plug-in component 30 may be installed on the client 12 and therefore on the client web browser 28 independent of the server 14. The plug-in component 30 of the client web browser 28 is processed on the client 12 to generate the keystore file or a plurality of keystore files. The processing of the plug-in component 30 on the client 12 may also generate the key pair in response to a successful authentication of the client 12 with the server 14.

According to one embodiment, the plug-in component 30 is an Active-X component that is installed with a single user 26 interaction via the client web browser 28. However, alternative executable components that may be added on to the client web browser 28 are also deemed to be within the scope of the present invention. These alternative executable components may include a .NET Smart Client on a Microsoft device, a Mozilla Firefox extension on any platform, flash software compatible with any platform, java software compatible with any platform or an Apple software component by way of example and not of limitation. The plug-in component 30 is compatible to the client's 12 chosen web browser 28. For example, the web browser 28 on the client 12 may include Internet Explorer, Mozilla Firefox, Apple Safari, etc. Importantly, the plug-in component 30 has the ability to identify the keystore file associated with the client web browser 28 incorporated on the client 12. After identifying the keystore file associated with the client web browser 28, the key pair which includes the public key and the private key may be stored in the keystore file. Different web browsers 28 have unique integration program libraries the must be understood and compatible with the plug-in component 30. For example, the Microsoft Application Programming Interface (API) set utilizes the CAPICOM libraries. The API set for Mozilla Firefox may include the Network Security Services (NSS) crypto libraries. The Apple platform may utilize the CSME libraries. The libraries are utilized to generate a Public Key Cryptography Standard (PKCS) request enabling a Certificate Authority (CA) to sign the request and validate the key pair generated by the plug-in component 30.

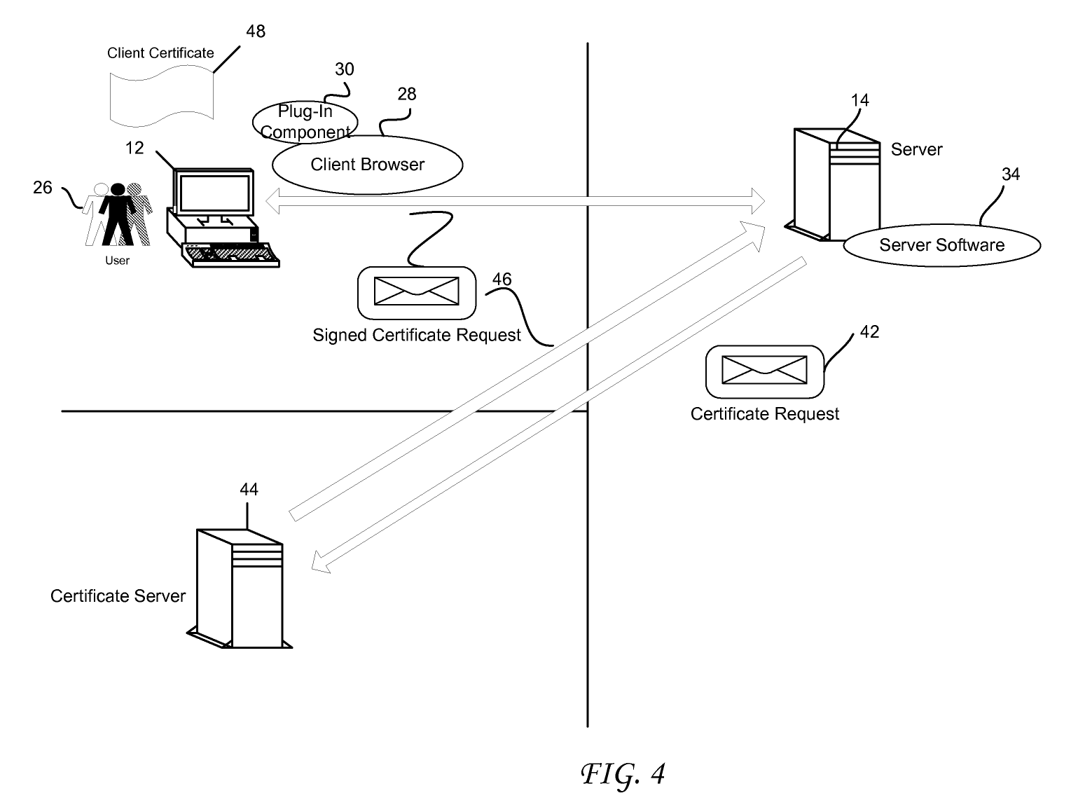

Referring again to the flow chart of FIG. 2, the method may proceed with generating a certificate request 120. Referring now to FIG. 4, the certificate request 42 is generated on the client 12. It is contemplated that the certificate request 42 is generated on the client 12 utilizing the plug-in software component 30 of the client web browser 28. The certificate request 42 includes the public key from the key pair generated by the plug-in component 30. One aspect of the present invention contemplates that the certificate request 42 is a PKCS #10. The certificate request 42 consists of three parts: certification request information, a signature algorithm identifier, and a digital signature on the certification request information. The certification request information consists of the client's name, the client's public key, and a set of attributes providing other information about the client 12. The process by which a certification request is constructed involves the following steps: (1) a CertificationRequestInfo value containing a subject name, a subject public key, and optionally a set of attributes is constructed by the client 12 requesting certification. (2) The CertificationRequestInfo value is signed with the subject client's private key. (3) The CertificationRequestInfo value, a signature algorithm identifier, and the client's signature are collected together into a CertificationRequest value. The CA fulfills the request by authenticating the requesting client and verifying the client's signature, and, if the request is valid, constructing an X.509 or other digital certificate from the name and public key, the issuer name, and the CA's choice of serial number, and signature algorithm.

The certificate request 42 may then be transmitted to the server software application 34 hosted on the server 14. In another embodiment, the certificate request 42 may be transmitted directly to a certificate server 44. It is also contemplated that the certificate request 42 is delivered via the client web browser 28. The certificate request 42 may be in the form of a PKCS #10 request. An aspect of the present invention contemplates the PKCS #10 request being an X.509 certificate request 42. In one embodiment of the present invention, the certificate server 44 is a CA. The certificate server 44 is configured to digitally sign the certificate request 42. In another embodiment of the present invention, the certificate server 44 is a server remote from the client device 12 and the server computer 14. In another embodiment of the present invention, it is contemplated that the certificate server 44 is hosted at the server computer 14.

In accordance with another embodiment of the present invention, the server software application 34 communicates with the certificate server 44 via a secured WSE 3.0 WebService call. According to the embodiment shown in FIG. 4, the certificate server 44 is the CA, and is understood to be within the control of a legitimate third party provider separate from the organization managing the server computer 14 and the enterprise database 36. In an alternative configuration not shown, the certificate server 44, the text message server 40 and the telephony server 38 are managed and maintained by the same organization managing the server computer 14. In yet another configuration, secure access is being enabled for web services. As understood, the term web service refers to a standardized system for supporting machine to machine interaction. In this case, the client 12 utilizes the plug-in software component 30 to authenticate with the server computer 14. The client certificate 48 thus generated is utilized to authenticate a W3 client to authenticate with the web service utilizing the information on the client certificate 48.

Upon receiving the certificate request 42 at the certificate server 44, the next step may require generating a digital certificate message 130 as referenced in the flowchart of FIG. 2. The certificate server 44 is configured to generate the digital certificate message. The digital certificate message generated at the certificate server 44 is transmitted in the form of a PKCS #7 response to the original PKCS #10 signing request requested by the client 12 and transmitted to the server software application 34 hosted on the server 14. The PKCS #7 response according to one embodiment of the present invention may be an X.509 certificate request response. The certificate request response is a signed certificate request 46. The certificate server 44 is configured to process the certificate request 42 and generate the signed certificate request 46. Following the signing of the certificate request 42, the digital certificate message is transmitted to the server software application 34 in the form of the signed certificate request 46. In another embodiment of the present invention, the signed certificate request 46 is transmitted to the client 12 directly from the certificate server 44. In this respect, the client web browser 28 is configured to receive the signed certificate request 46.

PKCS #7 is used to sign and/or encrypt messages under a PKI. It may also be used for certificate dissemination in response to a PKCS #10 message. For each signer, a message digest is computed on the content with a signer-specific message-digest algorithm. If the signer is authenticating any information other than the content, the message digest of the content and the other information are digested with the signer's message digest algorithm, and the result becomes the “message digest.” For each signer, the message digest and associated information are encrypted with the signer's private key. For each signer, the encrypted message digest and other signer-specific information are collected into a SignerInfo value. Certificates and certificate-revocation lists for each signer, and those not corresponding to any signer, are collected in this step. The message-digest algorithms for all the signers and the SignerInfo values for all the signers are collected together with the content into a SignedData value. A recipient verifies the signatures by decrypting the encrypted message digest for each signer with the signer's public key, then comparing the recovered message digest to an independently computed message digest. The signer's public key is either contained in a certificate included in the signer information, or is referenced by an issuer name and an issuer-specific serial number that uniquely identify the certificate for the public key.

Referring again to the flowchart of FIG. 2, the flow chart concludes with the step of storing the plurality of client certificate credentials 140. The signed certificate request 46 is received on the client 12 via the client web browser 28. In one embodiment it is contemplated that the plug-in software component 30 is configured to process the signed certificate request 46 received via the client web browser 28. The client 12 generates the client certificate 48 in response to the plug-in software component 30 processing the signed certificate request 46. In one embodiment of the present invention, the client certificate 48 is generated on the client 12 and the client certificate 48 is selectively stored in the appropriate keystore file. User 26 inputs are not required to store the plurality of client certificate credentials in the keystore file. An aspect of the present invention contemplates the plug-in component 30 being configured to automatically store the plurality of client certificate credentials in the required keystore files. The plug-in component 30 may selectively store the plurality of client certificate credentials in the keystore file or a plurality of keystore files. The plug-in component 30 is capable of placing the plurality of client certificate credentials in a specific keystore file or multiple keystore files if required. A single authentication of the client 12 to the server 14 may register a common set of key pairs in multiple keystore files. This avoids the requirement of the user 26 having to export the keystore file and then import the plurality of client certificate credentials in a separate server. This improved functionality is important to applications that utilize different programmatic services to retrieve the same cryptographic certificate credentials. The plug-in component 30 to the client web browser 28 does not require the end user 26 to manually import and export the key pairs or other certificate credentials. It is also contemplated that the client web browser 28 having the plug-in software component 30 is in communication with the server software application 34 and the certificate server 44 such that no user 26 or manual process is required after authentication of the client 12 to store the plurality of client certificate credentials in an appropriate keystore file or plurality of keystore files.

In one embodiment of the present invention, an encrypted keystore file is a storage facility for cryptographic keys and certificates. The encrypted keystore file may manage different entries, each entry implementing a different interface. It is contemplated that when the plug-in software component 30 pushes the plurality of client certificate credentials to the encrypted keystore files, it is accomplished by returning the most preferred implementation of the specific keystore file type available within the system. Another aspect of the present invention contemplates utilizing a default implementation for storing the plurality of client certificate credentials within an encrypted keystore file. The plug-in component 30 of the client web browser 28 is configured to generate a vacant encrypted keystore file on the client 12. Alternatively, the vacant encrypted keystore file may be generated in the memory of the client browser 28.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for storing a plurality of client certificate credentials via a client web browser into a keystore file, the method comprising:
establishing a secure data transfer link between a client and a server via the client web browser, the client web browser having a plug-in software component for generating the keystore file and a key pair during the process of establishing the secure data transfer link;
generating a certificate request on the client, the certificate request having a public key from the key pair generated by the plug-in software component;
transmitting the certificate request to a certificate server, the certificate server being configured to sign the certificate request;
receiving a signed certificate request on the client web browser; and
storing the plurality of client certificate credentials associated with the signed certificate request in the keystore file.

2. The method of claim 1, wherein the plurality of client certificate credentials include a digital certificate, a private key, a public key, a certificate chain, and a plurality of client identifying information.

3. The method of claim 1, wherein establishing the secure data transfer link between the client and the server requires a user to provide the server with client identifying information via the client web browser to successfully complete a multi-factor authentication process with the server.

4. The method of claim 1, wherein the plug-in software component is a browser-executable code transmitted to the client web browser from the server.

5. The method of claim 1, wherein the server is a Secure Sockets Layer (SSL) Virtual Private Network (VPN).

6. The method of claim 1, wherein the server hosts a server software application in communication with the client.

7. The method of claim 6, wherein the server software application is configured to receive or transmit the certificate request or the signed certificate request.

8. The method of claim 1, wherein the plug-in software component is configured to generate a plurality of keystore files.

9. The method of claim 1, wherein the certificate server is a certificate authority remote from the client and the server.

10. The method of claim 8, wherein the plug-in software component is configured to selectively store the plurality of client certificate credentials associated with the signed certificate request in the plurality of keystore files.

11. The method of claim 1, wherein the keystore file is selected from the group consisting of: Microsoft crypto API keystore, Java keystore, Apple keystore and NSS keystore.

12. The method of claim 1, wherein the plug-in software component is configured to identify the client web browser and store the plurality of client certificate credentials in the keystore files associated with the client web browser's coded libraries.

13. The method of claim 1, wherein the keystore file and the key pair are generated in response to the client establishing a valid identity and connection with the server prior to completing the secure data transfer link.

14. A system for storing a plurality of client certificate credentials, the system comprising:
a client web browser on a client for establishing a secure data transfer link between the client and a server;
a plurality of keystore files, the plurality of keystore files being generated by the client web browser;
a certificate server for receiving a certificate request generated by the client, the certificate server being configured to sign the certificate request; and
a plug-in software component to be processed by the client web browser for generating a key pair, the plug-in software component being configured to selectively store the plurality of client certificate credentials in at least one keystore file from the plurality of keystore files.

15. The system of claim 14, wherein the plurality of client certificate credentials include a digital certificate, a client private key, a client public key, a certificate chain, and a plurality of client identifying information.

16. The system of claim 14, wherein establishing the secure data transfer link requires the client to successfully complete a multi-factor authentication process with the server.

17. The system of claim 14, wherein the certificate server is a certificate authority remote from the client and the server.

18. The system of claim 14, wherein the client web browser generates a digital certificate in response to receiving a signed certificate request.

19. The system of claim 14, wherein the plug-in software component is a browser-executable code transmitted to the client web browser from the server.
